(19) United States
(12) Patent Application Publication
(10) Pub. No.: US 2008/0278908 A1
(43) Pub. Date: Nov. 13, 2008

(54) IMAGE SETTING DEVICE

(75) Inventors: Chung-Wei Wang, Taipei (TW); Yen-Ming Chen, Taipei (TW)

Correspondence Address: Muncy, Geissler, Olds & Lowe, PLLC, P.O. BOX 1364, FAIRFAX, VA, 22038-1364, US

(73) Assignee: ASUSTeK COMPUTER INC.

(21) Appl. No.: 12/118,193

(22) Filed: May 9, 2008

(30) Foreign Application Priority Data
May 9, 2007 (TW) 96116530

(51) Int. Cl. G06F 1/16; G03B 17/00; H04N 5/225

(52) U.S. Cl. 361/686; 396/50; 348/376; 348/E05.024

(57) ABSTRACT

An image setting device for sensing whether an image of a rotatable image capturing device needs to be set is disclosed. The rotatable capturing device has a photographic element and is capable of rotating in an electronic device. The image setting device includes a one-way magnetism sensor having a sensing direction and a magnet. The one-way magnetism sensor is capable of rotating with the photographic element. The magnet may be provided at the electronic device, and an N-S pole direction of the magnet is parallel to the sensing direction of one-way magnetism sensor.

### RELATED APPLICATIONS

This application claims priority to Taiwan Application Serial Number 96116530, filed May 9, 2007, which is herein incorporated by reference.

### BACKGROUND OF THE INVENTION

1. Field of the Invention

The invention relates to an image setting device and, more particularly, to an image setting device applied to a rotatable image capturing device.

2. Description of the Related Art

With the rapid development of the information science and technology, the application of the computer becomes more popular. Consumers demand more and more for the functions of the computer, and the peripheral electronic devices of the computer become more. Taking the notebook as an example, since the notebook is easy to carry, a user often carries about a notebook to process the daily work.

The image capturing device has been a basic equipment of the notebook nowadays. The notebook has a constant display direction while used, and the shooting direction of the image capturing device is often the same with the display direction of the notebook. Thus, the image capturing device is inconvenient to be used. Therefore, the image capturing device is designed to be capable of rotating in the notebook to provide more choices of shooting direction. For example, the shooting direction of the image capturing device may face the display or face away from the display.

However, the rotatable image capturing device has other problems, when the shooting direction of the rotatable image capturing device is turned over to be face away from the display, the disposition of the image capturing device is inverted where the shooting direction of the image capturing device faces the display. If the captured image is directly displayed by the display, the obtained image is inverted.

### BRIEF SUMMARY OF THE INVENTION

The objective of the invention is to provide an image setting device for sensing whether the image of the rotatable image capturing device needs to be set.

According to the objective of the invention, an image setting device for sensing whether an image of a photographic element needs to be set is provided. The photographic element is capable of rotating in an electronic device. The image setting device includes a one-way magnetism sensor and a magnet. The one-way magnetism sensor has a sensing direction. The one-way magnetism sensor may be capable of rotating with the photographic element, and the magnet may be provided at the electronic device. An N-S pole direction of the magnet is parallel to the sensing direction. The magnet also may be rotated with the photographic element, and the one-way magnetism sensor may be disposed at the electronic device. The electronic device has a rotatable base plate, and the photographic element and the one-way magnetism sensor may be installed at the rotatable base plate. The one-way magnetism sensor may be a one-way hall sensor, or it may include a two-way hall sensor and a magnetism shielding layer.

The invention also provides a rotatable image capturing device including a rotatable base plate provided at an electronic device, a photographic element provided at the rotatable base plate and an image setting device. The rotatable base plate and the photographic element are capable of rotating in the electronic device. The image setting device includes a one-way magnetism sensor and a magnet. The one-way magnetism sensor has a sensing direction. The one-way magnetism sensor may be capable of rotating with the photographic element, and the magnet may be provided at the electronic device. An N-S pole direction of the magnet is parallel to the sensing direction. The magnet also may be capable of rotating with the photographic element, and the one-way magnetism sensor may be provided at the electronic device. The electronic device has a rotatable base plate, and the photographic element and the one-way magnetism sensor may be installed in the rotatable base plate. The one-way magnetism sensor may be a one-way hall sensor, and it also may include a two-way hall sensor and a magnetism shielding layer.

In the invention, whether the image needs to be set is determined according to whether the one-way magnetism sensor senses the magnetic line of force. Thus, when the circuit board processes the image captured by photographic element, it may further set the captured image to output.

These and other features, aspects, and advantages of the present invention will become better understood with regard to the following description, appended claims, and accompanying drawings.

### BRIEF DESCRIPTION OF THE DRAWINGS

FIG. 1A and FIG. 1B are schematic diagrams showing the different states of an image setting device of a preferred embodiment of the invention, respectively;

FIG. 2A and FIG. 2B are schematic diagrams showing an image setting device of another preferred embodiment of the invention;

FIG. 3 is a schematic diagram showing a rotatable image capturing device of a preferred embodiment of the invention; and

FIG. 4 is a schematic diagram showing a rotatable image capturing device of another preferred embodiment of the invention.

### DETAILED DESCRIPTION OF THE EMBODIMENTS

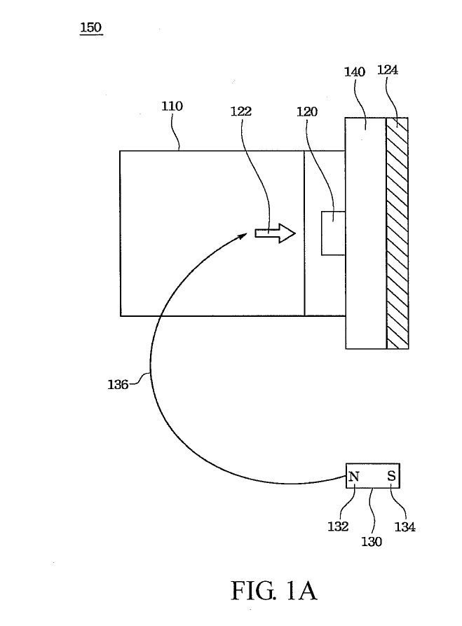

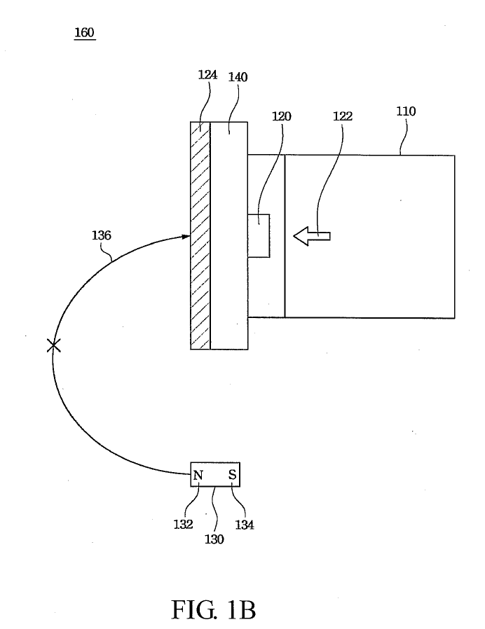

FIG. 1A and FIG. 1B are schematic diagrams showing different states of an image setting device of a preferred embodiment of the invention, respectively. The image setting device may be applied to a photographic element 110 which may be capable of rotating in an electronic device. The image setting device may be used to sense whether the image of the photographic element 110 needs to be set. The image setting device includes a one-way magnetism sensor 120 and a magnet 130. The one-way magnetism sensor 120 is capable of rotating in the electronic device with the photographic element 110. The one-way magnetism sensor 120 has a one-way sensing direction 122. The magnet 130 is provided at the electronic device and has an N pole 1321 and an S pole 134. The N-S pole direction of the magnet 130 is parallel to the sensing direction 122 of the one-way magnetism sensor 120.

Since the magnetic line of force 136 of the magnet 130 comes from the N pole 132 and goes back to the S pole 134. In the state 150 in FIG. 1A, the direction of the magnetic line of force 136 is the same with the sensing direction 122. Therefore, the magnetic line of force 136 may be sensed by the one-way magnetism sensor 120. When the photographic element 110 is rotated to another shooting direction in the electronic device, as shown in state 160 in FIG. 1B, the photographic element 110 in the state 150 in FIG. 1A is rotated by 180 degrees, and the direction of the magnetic line of force 136 is opposite to the sensing direction 122. Therefore, the magnetic line of force 136 cannot be sensed by the one-way magnetism sensor 120. The image setting device may utilize the one-way magnetism sensor 120 to sense whether the magnetic line of force 136 exists to determine whether the image needs to be set.

The electronic device may have a rotatable base plate 140, and the photographic element 110 and the one-way magnetism sensor 120 may be installed in the rotatable base plate 140. The rotatable base plate 140 may include a circuit board which may process signals of the one-way magnetism sensor 120 and set the image of the photographic element 110. For example, in FIG. 1A, the image captured by the photographic element 110 is an erect image, and the one-way magnetism sensor 120 may normally sense the magnetic line of force 136 sent by the magnet 130. In FIG. 1B, the image captured by the photographic element 110 is a inverted image, and the one-way magnetism sensor 120 cannot sense the magnetic line of force 136 sent by the magnet 130 successfully. At that moment, the circuit board connected to the one-way magnetism sensor 120 and the photographic element 110 in the rotatable base plate 140 can invert the outputted image by 180 degrees to process the image to be a normal erect image.

One-way magnetism sensor 120 may be a single hall sensor installed in the rotatable base plate 140, or the one-way magnetism sensor 120 may include a two-way hall sensor and a magnetism shielding layer 124. The two-way hall sensor may be installed in the rotatable base plate 140. The magnetism shielding layer is attached to a surface of the rotatable base plate 140 opposite to the sensing direction 122.

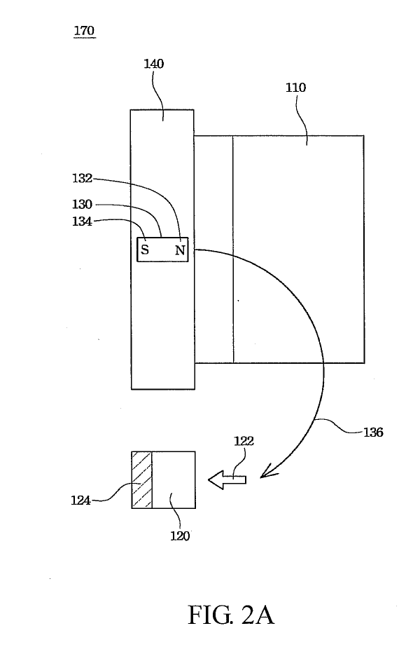

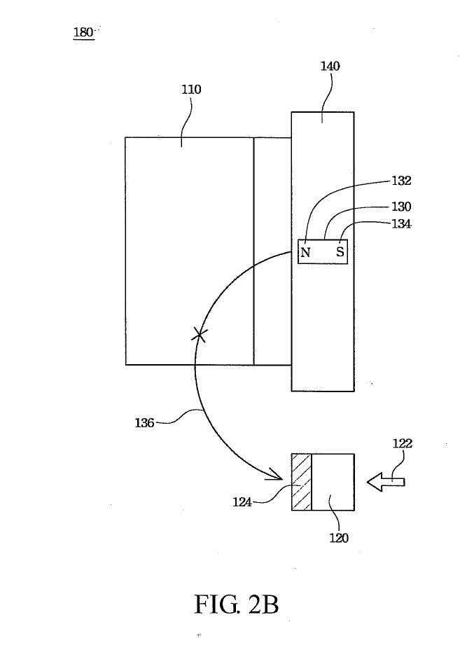

FIG. 2A and FIG. 2B are schematic diagrams showing different states of an image setting device of another preferred embodiment of the invention, respectively. The image setting device may use the one-way magnetism sensor 120 to sense the magnetic line of force 136 sent by the magnet 130 to determine whether the image of the photographic element 110 needs to be set. In the embodiment, the one-way magnetism sensor 120 may be provided at the electronic device, and the photographic element 110 and the magnet 130 may be provided at the rotatable base plate 140. The magnet 130 has an N pole 132 and an S pole 134, and the N-S pole direction of the magnet 130 is parallel to the sensing direction 122 of the one-way magnetism sensor 120. The one-way magnetism sensor 120 may be a one-way hall sensor, or it may include a two-way hall sensor and a magnetism shielding layer 124. The two-way hall sensor may be installed in the electronic device, and the magnetism shielding layer 124 is attached to one surface of the two-way hall sensor opposite to the sensing direction 122.

Since the magnetic line of force 136 of the magnet 130 comes from the N pole 132 and goes back to S pole 134, in the state 170 in FIG. 2A, the direction of the magnetic line of force 136 is the same with the sensing direction 122. Therefore, the magnetic line of force 136 is sensed by the one-way magnetism sensor 120. When the photographic element 110 is rotated to another shooting direction in the electronic device, as shown in the state 180 in FIG. 2B, the photographic element 110 in the state 170 in FIG. 2A is rotated by 180 degrees, and the direction of the magnetic line of force 136 is opposite to the sensing direction 122. Therefore, the magnetic line of force 136 cannot be sensed by the one-way magnetism sensor 120. The image setting device may use the one-way magnetism sensor 120 to sense whether the magnetic line of force 136 exists to determine whether the image needs to be set.

The electronic device may have a rotatable base plate 140, and the photographic element 110 and the one-way magnetism sensor 120 may be installed in the rotatable base plate 140. The rotatable base plate 140 may include a circuit board which may process the signals of the one-way magnetism sensor 120 and set the image of the photographic element 110. For example, in FIG. 2A, the image captured by the photographic element 110 is an erect image, and the one-way magnetism sensor 120 may normally sense the magnetic line of force 136 sent by the magnet 130. In FIG. 2B, the image captured by the photographic element 110 is a inverted image, and the one-way magnetism sensor 120 cannot sense the magnetic line of force 136 sent by the magnet 130 successfully. At that moment, the circuit board connected to the one-way magnetism sensor 120 and the photographic element 110 in the rotatable base plate 140 inverts the outputted image by 180 degrees to process the image to be an erect image.

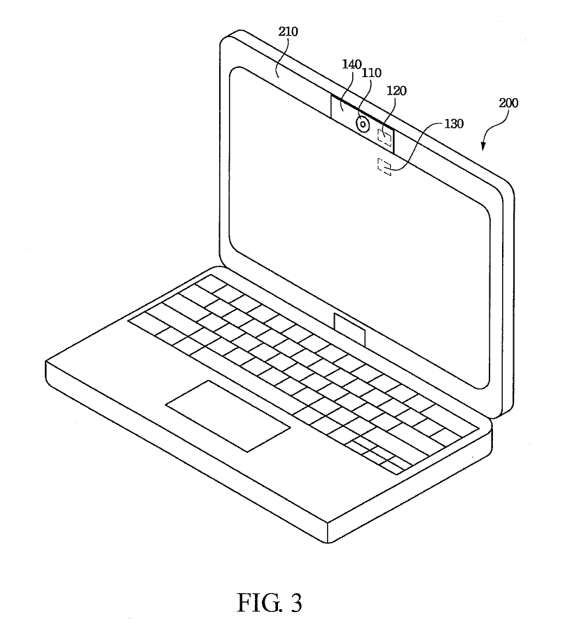

FIG. 3 is a schematic diagram showing a rotatable image capturing device of a preferred embodiment of the invention. The rotatable image capturing device may be applied to the electronic device such as a notebook 200, and it is capable of rotating in the notebook 200 to provide two shooting directions. The image setting device is used to sense that whether the image of the rotatable image capturing device needs to be set. The rotatable image capturing device may be disposed at the display casing 210 of the notebook 200, and it includes a rotatable base plate 140 assembled at the display casing 210, a photographic element 110 and one-way magnetism sensor 120 provided on the rotatable base plate 140 and a magnet 130 fixed at the display casing 210.

Refer to FIG. 1A and FIG. 3. The sensing direction 122 of the one-way magnetism sensor 120 is parallel to the N-S pole direction of the magnet 130. One-way magnetism sensor 120 may be a one-way hall sensor, or the one-way magnetism sensor 120 may include a two-way hall sensor and a magnetism shielding layer 124. The two-way hall sensor may be installed at the rotatable base plate 140, and the magnetism shielding layer 124 may be attached to one surface of the rotatable base plate 140 opposite to the sensing direction 122.

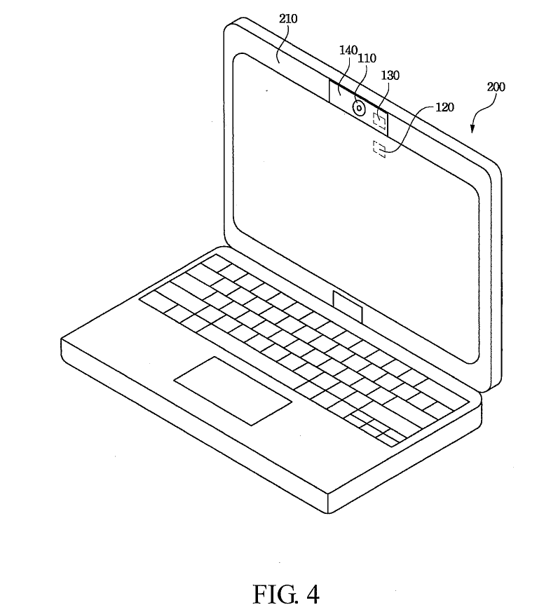

FIG. 4 is a schematic diagram showing a rotatable image capturing device of another preferred embodiment of the invention. The rotatable image capturing device may be disposed at the display casing 210 of the notebook 200, and it includes a rotatable base plate 140 assembled at the display casing 210, a photographic element 110 and a magnet 130 provided on the rotatable base plate 140 and a one-way magnetism sensor 120 fixed at the display casing 210.

Refer to FIG. 1B and FIG. 4. The sensing direction 122 of the one-way magnetism sensor 120 is parallel to the N-S pole direction of the magnet 130. The one-way magnetism sensor 120 may be a one-way hall sensor, or the one-way magnetism sensor 120 may include a two-way hall sensor and a magnetism shielding layer 124. The two-way hall sensor may be installed at the display casing 210, and the magnetism shielding layer 124 may be attached to one surface of the two-way hall sensor opposite to the sensing direction 122.

The circuit board at the rotatable base plate 140 may process the signals of the photographic element 110 and the one-way magnetism sensor 120, and the processed image is transferred to the display to output.

As described in the preferred embodiment of the invention, the invention has following advantages. In the invention, the one-way magnetism sensor is used to sense the magnetic line of force to determine whether the image needs to be set. Thus, when the circuit board processes the image captured by the photographic element, it can further set the captured image and then output the image.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An image setting device for sensing an image of a photographic element needs to be set, wherein the photographic element is capable of rotating in an electronic device, the image setting device comprising:
a one-way magnetism sensor which rotates with the photographic element and has a sensing direction; and
a magnet provided at the electronic device, wherein an N-S pole direction of the magnet is parallel to the sensing direction.

2. The image setting device according to claim 1, wherein the one-way magnetism sensor is a one-way hall sensor.

3. The image setting device according to claim 1, wherein the electronic device has a rotatable base plate, and the photographic element and the one-way magnetism sensor are installed at the rotatable base plate.

4. The image setting device according to claim 3, wherein the electronic device is a notebook having a display casing, the rotatable base plate is assembled at the display casing, and the magnet is fixed at the display casing.

5. The image setting device according to claim 3, wherein the one-way magnetism sensor comprises a two-way hall sensor installed at the rotatable base plate and a magnetism shielding layer attached to one surface of the rotatable base plate opposite to the sensing direction.

6. An image setting device for sensing whether an image of a photographic element needs to be set, wherein the photographic element is capable of rotating in an electronic device, the image setting device comprising:
a one-way magnetism sensor provided at the electronic device and having a sensing direction; and
a magnet which rotates with the photographic element, wherein an N-S pole direction of the magnet is parallel to the sensing direction.

7. The image setting device according to claim 6, wherein the one-way magnetism sensor is a one-way hall sensor.

8. The image setting device according to claim 6, wherein the electronic device has a rotatable base plate, and the photographic element and the magnet are installed at the rotatable base plate.

9. The image setting device according to claim 8, wherein the electronic device is a notebook having a display casing, the rotatable base plate is assembled at the display casing, and the one-way magnetism sensor is fixed at the display casing.

10. The image setting device according to claim 9, wherein the one-way magnetism sensor comprises a two-way hall sensor installed at the display casing and a magnetism shielding layer attached to one surface of the two-way hall sensor opposite to the sensing direction.

11. A rotatable image capturing device comprising:
a rotatable base plate having a circuit board and provided at an electronic device;
a photographic element provided at the rotatable base plate, wherein the rotatable base plate and the photographic element are capable of rotating in the electronic device;
a one-way magnetism sensor having a sensing direction and provided at the rotatable base plate; and
a magnet provided at the electronic device, wherein an N-S pole direction of the magnet is parallel to the sensing direction.

12. The rotatable image capturing device according to claim 11, wherein the one-way magnetism sensor is a one-way hall sensor.

13. The rotatable image capturing device according to claim 11, wherein the one-way magnetism sensor comprises a two-way hall sensor installed at the rotatable base plate and a magnetism shielding layer attached to one surface of the rotatable base plate opposite to the sensing direction.

14. The rotatable image capturing device according to claim 11, wherein the electronic device is a notebook having a display casing, the rotatable base plate is assembled at the display casing, and the magnet is fixed at the display casing.
